(19) United States
(12) Patent Application Publication
(10) Pub. No.: US 2025/0254267 A1
(43) Pub. Date: Aug. 7, 2025

(54) COLLECTING AND SHARING LIVE VIDEO AND SCREEN FEEDS OF PARTICIPANTS IN A VIRTUAL COLLABORATION ROOM

(71) Applicant: Global Imports L.L.C., Sammamish, WA (US)

(72) Inventor: Sameer Maini, Sammamish, WA (US)

(21) Appl. No.: 19/043,350

(22) Filed: Jan. 31, 2025

Related U.S. Application Data
(63) Continuation of application No. 18/403,590, filed on Jan. 3, 2024, now abandoned.
Application No. 18/403,590 is a continuation of application No. 17/098,048, filed on Nov. 13, 2020, now Pat. No. 11,882,381.
(60) Provisional application No. 63/064,250, filed on Aug. 11, 2020.

(51) Int. Cl. H04N 7/15; G06V 40/16

(52) U.S. Cl. CPC H04N 7/15; G06V 40/174

(57) ABSTRACT

Systems and methods for sharing data streams in a virtual collaboration room. The method includes receiving a user video data stream from a user device for display to one or more other participants in the virtual collaboration environment and receiving a user screen sharing data stream from the user device for display to the one or more other participants in the collaboration environment. The method further includes providing a participant video data stream and a participant screen sharing data stream associated with each participant of the one or more other participants in the collaboration environment to the user device, the data streams associated with each participant configured for simultaneous display with each other participant data stream at the user device and simultaneous display with the user video data stream and the user screen sharing data stream to the one or more other participants.

### CROSS-REFERENCE TO RELATED APPLICATION(S)

The present application is a continuation of U.S. patent application Ser. No. 18/403,590 filed on Jan. 3, 2024, titled “Collecting and sharing live video and screen feeds of participants in a virtual collaboration room,” which is a continuation of U.S. patent application Ser. No. 17/098,048 filed on Nov. 13, 2020, titled “Collecting and sharing live video and screen feeds of participants in a virtual collaboration room,” which claims priority to U.S. Provisional Patent Application No. 63/064,250 filed on Aug. 11, 2020, titled “Collaboration application that enables call center trainers/managers to see multiple video and screen from participant at the same time,” all of which are incorporated herein in their entirety by reference.

### TECHNICAL FIELD

Embodiments of the present invention are directed to a screen sharing and video collaboration system and method, and more specifically to a new and useful method for sharing real time screen and video feeds of participants to a moderator or supervisor in a virtual collaboration environment.

### BACKGROUND

Due to a rise in telecommuting, remote work, and remote schooling, more and more people are now working from home or attending school from home and utilizing live video streaming and/or screen-sharing services. As a moderator or supervisor (e.g., a supervisor in a call center or a teacher in a classroom), there is challenge in training and monitoring participants of the call while they work or learn. Conventional solutions either allow one-on-one collaboration between the moderator and a participant or group collaboration, but do not allow for one supervisor or moderator to consistently moderate a group of participants by monitoring both video activity and screen activity of each participant. Conventional solutions also do not allow segregation of video/screen data between moderators and participants.

In conventional collaboration software, there is one moderator who shares their screen. To view other participants' screens, the moderator who is presenting stops presenting and then other participants can share their screen.

Furthermore, in conventional collaboration software, what is presented (e.g., a shared screen) by participants is shared to everyone. This can be a distraction for other participants in a focused environment where they are looking at each other participant's video and/or screen and not the moderator(s) video and or screen. Additionally, in conventional collaboration software, when multiple participants are present, it is difficult for the moderator to get feedback of engagement of each of the participants based on the use of facial recognition software.

### SUMMARY

Therefore, there is a need for a software application that allows one supervisor or moderator to efficiently monitor multiple participants in a video call, such as a virtual collaboration room. Additionally, if there are multiple participants, the software will provide real time feedback of the engagement of the participants based on facial recognition.

One embodiment provides a computer-implemented method for sharing data streams in a virtual collaboration room. The computer-implemented method includes receiving, at a server, a user video data stream from a user device for display to one or more other participants in the virtual collaboration environment and receiving, at the server, a user screen sharing data stream from the user device for display to the one or more other participants in the virtual collaboration environment. The computer-implemented method further includes providing, with the server, a participant video data stream and a participant screen sharing data stream associated with each participant of the one or more other participants in the virtual collaboration environment to the user device, the participant video data stream and the participant screen sharing data stream associated with each participant configured for simultaneous display with each other participant video data stream and participant screen sharing data stream at the user device and simultaneous display with the user video data stream and the user screen sharing data stream to the one or more other participants.

Another embodiment provides one or more computer-readable media storing instructions that, when executed by an electronic processor, cause the electronic processor to execute a process. The process includes receiving, at a server, a connection from a user device, the connection indicating a moderator is joining a virtual collaboration environment; receiving, at the server, a moderator video data stream from the user device for display to one or more other participants in the virtual collaboration environment; and receiving, at the server, a moderator screen sharing data stream from the user device for display to one or more other participants in the virtual collaboration environment. The process further includes providing, with the server, a participant video data stream and a participant screen sharing data stream associated with each participant of the one or more other participants in the virtual collaboration environment to the user device, the participant video data stream and the participant screen sharing data stream associated with each participant configured for simultaneous display with each other participant video stream and participant screen sharing data stream at the user device and simultaneous display with the user video data stream and the user screen sharing data stream to the one or more other participants, wherein the one or more other participants in the virtual collaboration environment do not receive the participant video data stream and the participant screen sharing data stream associated with other participants of the one or more other participants

Yet another embodiment provides a computer-implemented method. The method includes receiving, at a server, a user video data stream from a user device for display to one or more other participants in the virtual collaboration environment; receiving, at the server, a user screen sharing data stream from the user device for display to one or more other participants in the virtual collaboration environment; and providing, with the server, a participant video data stream and a participant screen sharing data stream associated with each participant of the one or more other participants in the virtual collaboration environment to the user device, the participant video data stream and the participant screen sharing data stream associated with each participant configured for simultaneous display with each other participant video stream and participant screen sharing data stream at the user device and simultaneous display with the user video data stream and the user screen sharing data stream to the one or more other participants. The computer-implemented method further includes detecting, from the participant video data stream associated with each participant of the one or more other participants, one or more faces in the participant video data stream; detecting, from the participant video data stream associated with each participant of the one or more participants, a facial expression of each face of the one or more faces; and providing an indicator on the user device of the facial expression of at least one face of the one or more faces.

A further embodiment provides a system for sharing data streams in a virtual collaboration environment. The system includes a user device and a server including an electronic processor. The electronic processor is configured to receive a connection from a user device, the connection indicating a moderator is joining a virtual collaboration environment; receive a moderator video data stream from the user device for display to one or more other participants in the virtual collaboration environment; receive a moderator screen sharing data stream from the user device for display to one or more other participants in the virtual collaboration environment; and provide a participant video data stream and a participant screen sharing data stream associated with each participant of the one or more other participants in the virtual collaboration environment to the user device, the participant video data stream and the participant screen sharing data stream associated with each participant configured for simultaneous display with each other participant video stream and participant screen sharing data stream at the user device, and simultaneous display with the user video data stream and the user screen sharing data stream to the one or more other participants, wherein the one or more other participants in the virtual collaboration environment do not receive the participant video data stream and the participant screen sharing data stream associated with other participants of the one or more other participants. The processor is further configured to detect, from the participant video data stream associated with each participant of the one or more other participants, one or more faces in the participant video data stream; detect, from the participant video data stream associated with each participant of the one or more participants, a facial expression of each face of the one or more faces; and provide an indicator on the user device of the facial expression of at least one face of the one or more faces.

### BRIEF DESCRIPTION OF THE DRAWINGS

FIG. 1 is a block diagram illustrating an overview of an environment in which some implementations of the invention can operate.

FIG. 2 is a block diagram illustrating various software components of an environment in which some implementations can operate.

FIG. 3 is a flow diagram illustrating a process for collecting and sharing live video and screen feeds of participants used in some implementations.

FIG. 4 is a block diagram of a moderator's screen with multiple participants in a collaboration room.

FIG. 5 is a block diagram of a participant's screen.

FIG. 6 is a flow diagram illustrating a process used for displaying to the moderator(s) participants facial expression and number of faces detected on each participants webcam.

FIG. 7 is a block diagram of a web page displayed after user authentication where a user can select an audio device and video device for input and a collaboration environment to join.

### DETAILED DESCRIPTION

The present disclosure describes a system that enables moderators to collaborate with multiple participants by viewing each participant's screen and video simultaneously. In addition, participants are able to view the moderator(s) screen and video along with his or her own screen.

This system enables moderators to receive real-time feedback on participants in a virtual meeting room, including a facial expression of each participant as well as a number of faces detected in each video stream presented to the moderator. This feedback is critical for moderators to judge engagement of participants and detect the presence of other people in the room or at the workstation of each participant.

Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below. Several implementations are discussed below in more details in reference to the figures.

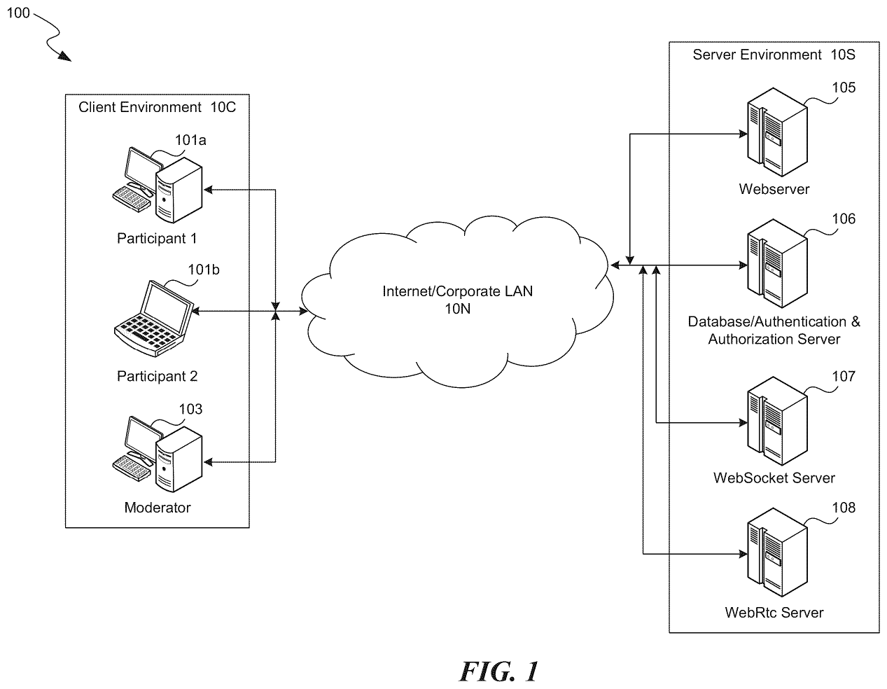

FIG. 1 is a block diagram illustrating an overview of an environment 100 in which some implementations of the disclosed technology can operate. The environment 100 includes a client environment 10C and all the components that moderator and participants (collectively called as users) use, connected to a server environment 10S where all the applications are connected by a network 10N.

Client environment 10C include one or more participants computing devices 100A-B. In the illustrated embodiment, device 101A is a desktop computer with a monitor that has video and audio capability, device 101B is a laptop that has audio and video capability, and device 103 is a moderator computer with a monitor that has video and audio capability (collectively referred to as “the devices”). It is to be understood that the device 101A, the device 101B, and the device 103 may be any form of personal computing device, such as a desktop computer.

The environment 100 includes a web server 105 configured to process Hypertext Transfer Protocol Secure (“https”) requests. The web server 105 includes have a public internet protocol “IP”) address and a private IP address. The web server 105 is configured to send and receive messages or data streams from other computing devices using various communication protocols, such as https. Database server 106 is a server that is used for authentication and authorization of users and storing of data. WebSocket server 107 is a server that is used to process WebSocket traffic. WebSocket is a computer communications protocol that provides communications over a single transmission control protocol (“TCP”). WebRTC server 108 is a server used to manage all Web Real-Time Communication (“WebRTC”) traffic. Each server may include one or more processors, memory, and network interface(s). The servers are configured to communicate with the other servers and the devices within the environment 100 over the network 10N.

These are only examples of some of the devices that may be used in the environment 100 and other embodiments can include other types and/or numbers of computing devices. For example, device 101A may be a thin client (e.g., a low performance computing device optimized for establishing a remote connection with a server) that includes an external web camera. Other examples of computing systems, environments, and/or configurations that may be suitable for use with the technology include, but are not limited to, personal computers, video conference consoles, server computers, handheld or laptop devices, cellular telephones or smart phones, tablet devices, multiprocessor systems, microprocessor-based systems, set-top boxes, programmable consumer electronics, network PCs, minicomputers, mainframe computers, distributed computing environments that include any of the above systems or devise, or the like.

In some implementations the web server 105, the database server 106, the WebSocket server 107, and the WebRTC server 108 (collectively referred to as “the servers”) may all be deployed on a single virtual or physical machine. In other embodiments, although each server is displayed logically as a single server, the servers can each be a distributed computing environment encompassing multiple computing devices located at the same or at geographically disparate physical locations.

In some implementations, the database server 106 may be two separate servers, one server used for storing database transactions and the other server used as an authentication and authorization server, which could be an enterprise Lightweight Directory Access Protocol (“LDAP”) server or any other identity management server that would provide authentication and authorization capabilities (e.g., used to allow users to log in to the environment).

The network 10N may be a local area network (LAN), a wide are network (WAN) or any other form of suitable wired or wireless communication means, (e.g., the client environment 10C may connect to the server environment 10S using a public Wi-Fi connection).

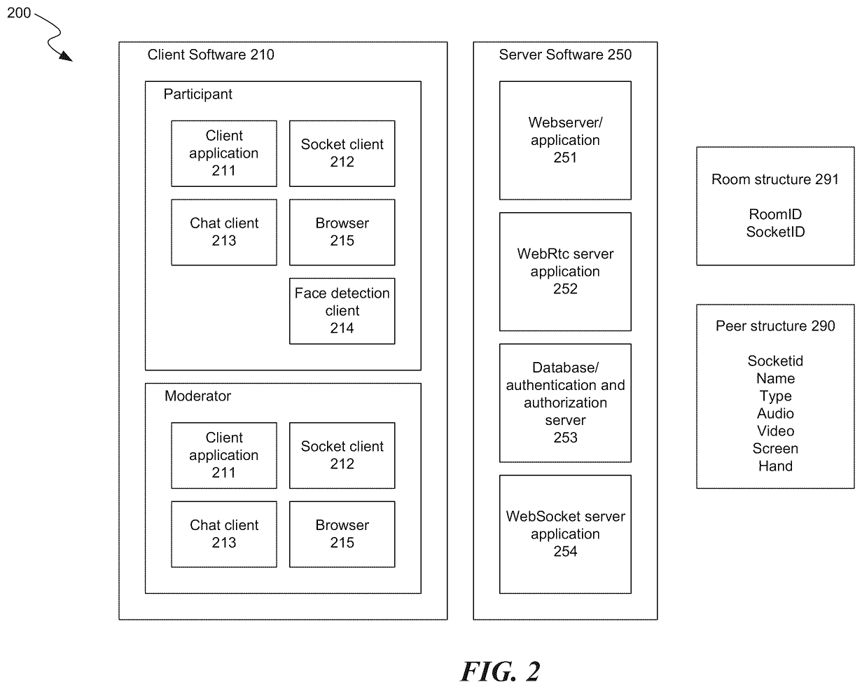

FIG. 2 is a block diagram illustrating components 200 which in some implementations can be used in a system, such as system 100, employing the disclosed technology. The components 200 may include commonly off the shelf products (“COTS”) and/or one or more specialized software applications. As discussed above, the system 100 implementing the disclosed technology may use various hardware components mentioned in regards to client environment 10C and server environment 10S.

Client application 211 is a software application responsible for presentation of video, screen, and audio streams for users, such as the moderator and the participants.

Socket client 212 is responsible for establishing a socket on a user's computer (e.g., device 101a), allowing communication between the user's computer and a socket server 254 in the form of data streams. Data streams from the user's computer are passed via the socket to the socket server 254.

Chat client 213 is responsible for taking data from users in a chat interface on the user's computer and passing it to socket client 212 and receiving data from the socket client 212. The chat client 213 is also responsible for displaying the data on the client application 211.

Face detection client 214 is loaded on the client application 211 for participants and gathers data about a number of faces detected from the webcam of the device associated with each participant. The face detection client 214 is also responsible for facial expression detection of participants. The face detection client 214 uses, for example, one or more machine learning platforms (such as Google Tensorflow) and one or more facial and/or object recognition algorithms, such as SSD Mobilenet V1 and ResNet-34 to determine a number of faces in the video stream and the expression of each face in the video stream by, for example, identifying facial features by extracting landmarks from the video stream of the participant. The face detection client 214 detects the expression of the face of the participants using, for example, the position of the eyes, the nose, the eyebrows, or other facial features of the participants. Based on the mentioned algorithms or other, similar algorithms, the face detection client 214 predicts a facial expression of the participant, for example by creating one or more scores based on the input to the algorithm(s), where the scores indicate probabilities that the participant is making a particular facial expression. The face detection client 214 passes both the number of faces and the facial expression of each face to the socket client 212. In one embodiment, the face detection client 214 then sends the highest probability score to the socket client 212.

Face detection client 214 enables the moderator to observe the level of engagement of the participants and is also critical for organizations that wish to protect confidential information that remote employees may be working on from unauthorized users who may be looking at the participant's screen. On the moderator client application 211, the color of the participant's name will change based on the participant's facial expression being detected by the face detection client 214, therefore alerting the moderator that the participant is distracted and not looking at the screen or away from their desk. In other embodiments, a different method of alerting the moderator, such as playing an audible tone or providing a different visual indication (e.g., a pop-up window, an alert badge, a banner, or the like) that the participant is distracted. The moderator client application 211 will also alert the moderator by adding of the number of faces being detected by the face detection client 214 next to each participant's name so the moderator is aware that there is another person in the video stream looking at the data on the participant's screen. Additionally, a participant's client application 211 includes an icon for raising a hand which alerts the moderator client application 211 that the participant needs attention or assistance.

Web Browser 215 may be any WebRTC-enabled COTS web browser, such as Google Chrome™, Mozilla Firefox™, Microsoft Edge™, and others.

Web server application 251 is responsible for serving http or http requests from client application 211. The web server application 251 gathers requests from the client application 211 and routes the requests to appropriate server software on the servers or to the appropriate server in the event the servers are all separate computing components.

WebRTC application 252 is a software application responsible for managing all WebRTC related activities, such as video, audio, and screen sharing streams. The WebRTC application 252 is hosted on the WebRTC server 108.

Database/authentication and authorization application 253 is a software application used for storing user profile information, which includes username, password and user category or role (moderator or participant).

Socket application 254 is a software application responsible for sending and receiving data to and from the socket client 212. Each new connection from the socket client 212 creates a peer in the socket application 254. The object that is created includes a data structure defined in peer data structure 290. The peer data structure 290 is used to track various SocketID numbers and what each SocketID is used for. Table 1 below describes fields of the peer data structure 290. The socket application 254 uses the peer data structure 290 of each peer with a created socket (e.g., each of the devices) to identify which users and streams are associated with the connection between a particular device and the socket application 254. Therefore, each user can have multiple peers depending on a type of data stream (Audio/Video/Screen) and a number of streams associated with the user, as each stream has its own peer.

TABLE 1

| Field Name | Definition |
|---|---|
| SocketID | Unique value generated by sockets server |
| | for each new connection |
| Name | Name of the user to whom this connection |
| | belongs to |
| Type | Whether the user is a Moderator or Participant |
| Audio | True if this SocketID is for audio |
| Video | True if this SocketID is used for Video |
| Screen | True if this SocketID is used to show |
| | a raised hand |

When a user selects a collaboration room to join (as described below), the socket application 254 checks to see if the selected collaboration room exists. If the collaboration room does not exist, a new room data structure 291 is created. The fields of the room data structure 291 are shown below in Table 2. In some embodiments, only moderators or supervisors can create a new room data structure. As new participants join an existing collaboration room, the socket server software 254 adds the SocketID of the peer data structure 290 associated with the user to the room.

TABLE 2

| Field Name | Definition |
|---|---|
| RoomID | Unique value given, if it does not exist. |
| SocketID | SocketID of the peer being connected from 290 |

Those skilled in the art will appreciate that the components illustrated in FIG. 1-2 described above, and in each of the flow diagrams discussed below may be altered in a variety of ways. For example, the socket application 254 could be replaced with a Representational State Transfer (“Rest”) Application Programming Interface (“API”) to handle all exchanges of data between the client application 211 and the socket application 254.

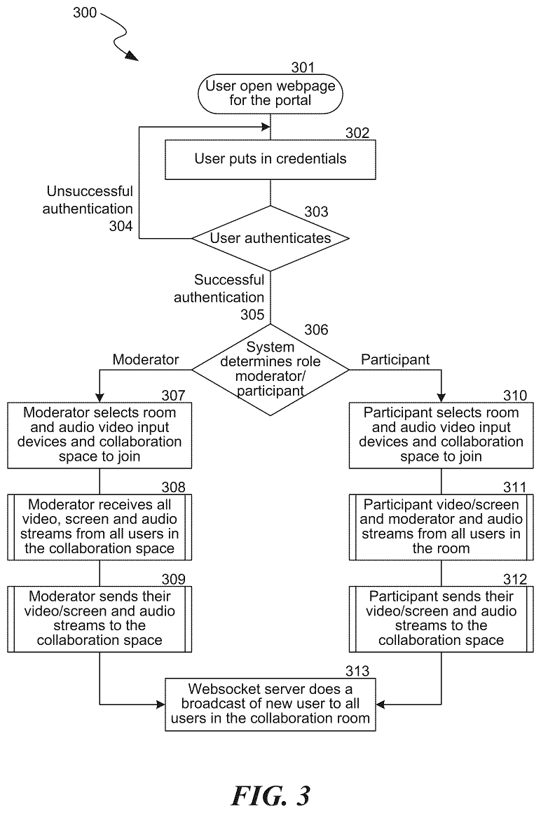

FIG. 3 is a flow diagram illustrating a process 300 for collecting and sharing live audio, video, and screen feeds of participants to a moderator according to one embodiment. Process 300 begin at block 301. At block 301, a user opens a COTS browser on the associated user device (such as device 101A). The user then enters the Uniform Resource Locator (“URL”) of the client application 211. The web server application 251 responds back to a Rest API call from the browser and launches client application 211.

At block 302, the user inputs login credentials via the browser into the client application 211. The client application 211 passes the login credentials to the web server application 251. The web server application 251 queries the database/authentication and authorization application 253. If user is successfully authenticated (305) (e.g., the login credentials exist in the database/authentication and authorization application) at block 303, the client Application 211 receives profile information associated with the user back from the web server application 251 (at block 306). If the user is not successfully authenticated (304) the client application 211, the user is redirected to the initial web page presented when the URL was input to access the client application 211. In some embodiments, the user may also be prompted or alerted that the login credentials were not accepted.

At block 307, if the user is a moderator or supervisor, the user is prompted to select which audio device and video device will be used as input. A similar process occurs at block 310 if the user is a participant. In both situations, the user is also prompted to select a collaboration room to join. This information will be gathered by the client application 211 and passed to socket client 212 which will send the data to socket application 254. The socket application 254 will check to see if the selected collaboration room exists based on room data structure 291 information stored in the socket application 254 and, if the selected collaboration room does not exist, the socket application 254 will create a new collaboration room.

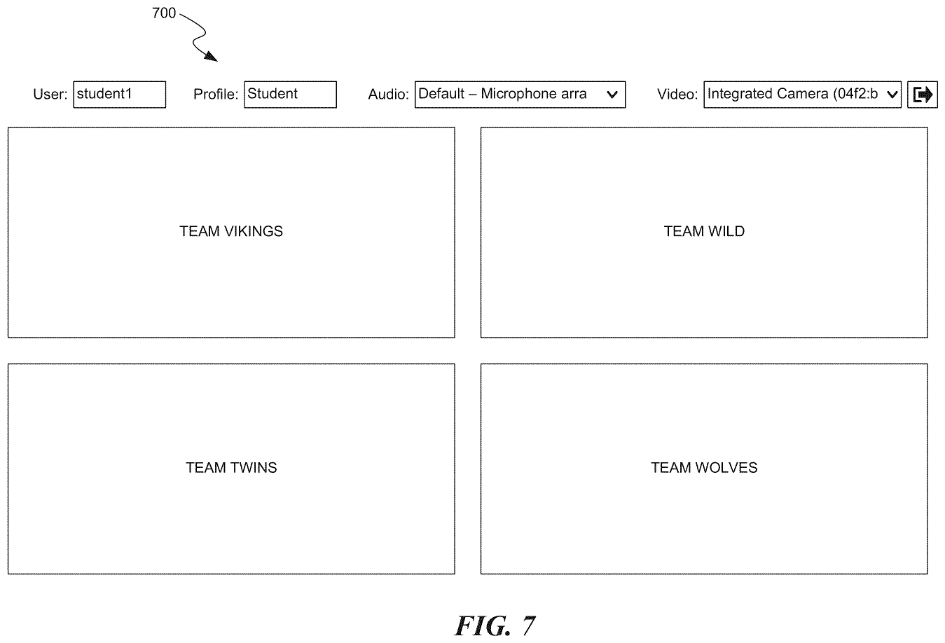

FIG. 7 is an example of a web page 700 where a user can both select audio and video source devices and select a collaboration room to join according to one embodiment. In this example username student1, whose profile is student (participant), has selected the default microphone as an audio input and an integrated camera as a video source. The user can also select any one of the four collaboration rooms to start collaborating with other users in the same collaboration room.

Returning to FIG. 3, at block 308, socket application 254 retrieves each SocketID that are associated with the selected collaboration room and passes the list of SocketIDs to the socket client 212. Socket client 212 will passes the audio, video, and/or screen sharing data streams associated with each SocketID to the client application 211. The client application 211 also receives WebRTC traffic from WebRTC application 252.

At block 309, when a moderator associated with the selected collaboration room starts to share his video, screen, and audio using his client application 211, the client application 211 will send data to the socket client 212, which in turn sends that data to the socket application 254. Socket application 254 creates a new peer for each one of the input streams (audio, video, screen).

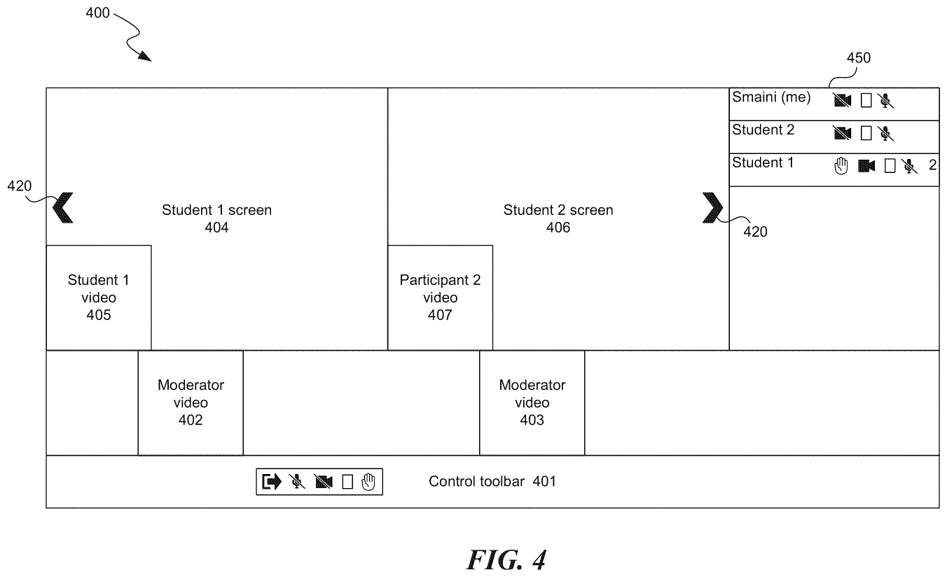

FIG. 4 illustrates an example of a moderator screen 400 according to one embodiment. The moderator screen 400 illustrates the collaboration room as the collaboration room receives multiple video and screen data streams from participants via the WebRTC server 108. At the bottom of the moderator screen 400 is a toolbar 401. The toolbar 401 includes all audio, video, and screen sharing controls, such as mute, stop video display, start and stop screen sharing functionality, and others. The moderator's own video and screen are displayed in sections 402 and 403, respectively. FIG. 4 also illustrates a layout with two participants and the screen and video streams associated with each of the two participants. The screen of Participant One is shown in section 404 and the video of Participant One is shown in section 405. The screen of Participant Two is shown in section 406 and the video of Participant Two is shown in section 407. As the number of participants increase, each participant will have their own section of screen and video displayed in the collaboration room on the moderator screen 400.

This layout can be customized. For example, a number of participants whose video and screen sharing streams are shown can be limited to a defined number per page. If the number of participants is greater than this defined number per page, the moderator can use arrows 420 to move between different pages. As an example, if you have nine participants as a defined number of participants on a page and have sixteen participants in the collaboration room, the moderator will have the ability to look at all sixteen participants by clicking on arrows 420 to move to the next page.

This is different from conventional video collaboration software applications, which a defined number of participants and have no ability to see all participants via a paging mechanism.

The method of showing multiple participants' screens and video for the moderator to oversee multiple participants also differ from conventional video collaboration software applications, which show only video of participants and the moderator being the one that typically shares his or her screen. In contrast, the disclosed invention enables the moderator to see what the participants activities are via both screen sharing and video. This can be very useful in a training environment and well as in remote collaboration environments including employees, students, supervisors, and moderators.

In another embodiment it is possible to have multiple moderators in a single collaboration room. In this embodiment, in addition to each moderator seeing each participant's screen sharing stream and video stream, each moderator can also see the other moderators' screen streams and video streams.

FIG. 4 also illustrates the chat client 213 (in section 450), where all the participants' names are displayed, and what their control toolbar status is will be displayed (e.g., if the participant is muted, has stopped sharing video, and the like). This is also the section where face detection data is also displayed. In this example, one collaboration room includes a moderator with the username smaini and two participants with usernames student1 and student2, respectively. Student1 is sharing video and has also raised their hand. Face detection application 214 is detecting a normal or neutral facial expression for student1 and is detecting two different faces in the video stream of student 1. The number of faces detected in each video stream is displayed next to the participant's name, and the color that the participant's name is being displayed in is based on the participant's facial expression. As described above, a different indicator (such as an audio tone, a pop-up window, a banner, an alert badge, or another visual indicator) may be provided instead.

Table 3 illustrates the relationship between a detected facial expression of a participant and a color to display that participant's name in.

TABLE 3

| Expression | Color |
|---|---|
| Neutral | Lawn Green |
| Happy | Dark Green |
| Sad | Orange |
| Angry | Dark red |
| Fearful | Orange Red |
| Disgusted | Yellow |
| Surprised | Blue |

At block 311 socket server 254 will retrieve all audio SocketIDs and moderator SocketIDs for the moderator(s) that is present for the selected collaboration room. Socket client 212 will pass the streams to client application 211 which will receive WebRTC traffic from WebRTC application 252, which then allows the client application 211 to display the moderator's screen and video. At block 312, the participant sends an audio stream, a video stream, and a screen sharing stream to the collaboration room to share to the moderator.

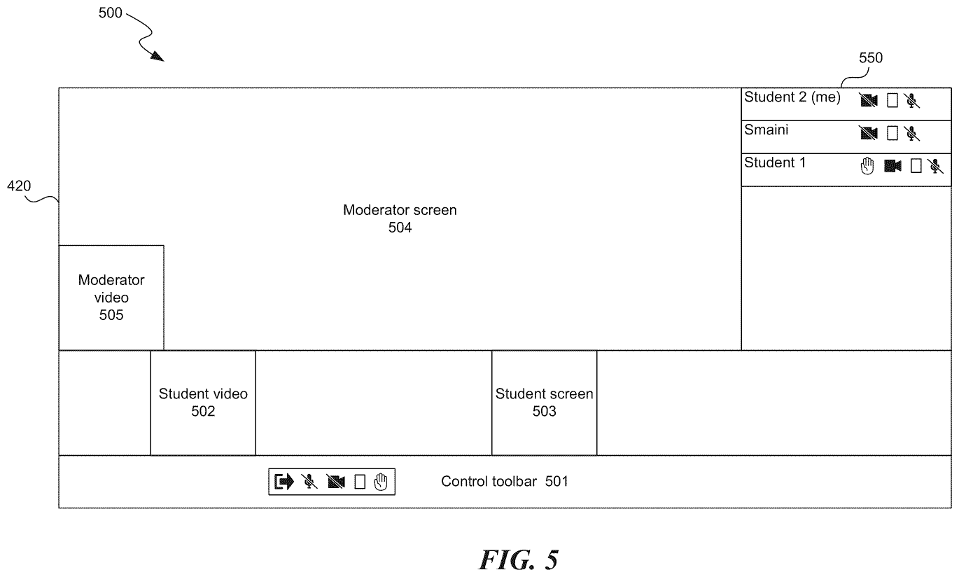

FIG. 5 illustrates an example of a participant screen 500 as it receives moderator video/screen streams from the WebRTC server 108 according to one embodiment.

Section 501 is a participant toolbar. The participant toolbar 501 also includes the option to raise a hand for chat purposes.

Section 502 and Section 503 are similar to section 402 and section 403, but instead of showing the moderator's screen and video, the participant's own video and screen streams are shown.

Section 504 shows participant screen and Section 505 shows the moderator's stream and moderator's video, respectively. This section is different from moderator screen described above as a participant does not have the ability to see other participants. This enables the participants to focus on moderator content and not be distracted by other participants.

Section 550 is the participants' chat client 213. In contrast to the moderator chat client, the participants' chat client 213 cannot see participant name color (based on participant facial expression) or number of faces detected in the video stream of the participant, as this is information privileged only to the moderator. This is done to protect other participants' privacy. Unlike conventional collaboration application where all participants can see other participants' video and screen being shared, this collaboration application only shows the moderator details of participants' video and screen streams.

At block 313, the socket application 254 broadcasts a notification to all users in the collaboration room when a new user joins. Conventional collaboration application typically use a polling mechanism where the collaboration application would query the WebRTC application 252 for all the available streams at a given time interval. Broadcasting when new users join in reduces the bandwidth needed as compared to a conventional collaboration application polling for peers at a specific interval, as now data will only be pushed to client applications when there is a change.

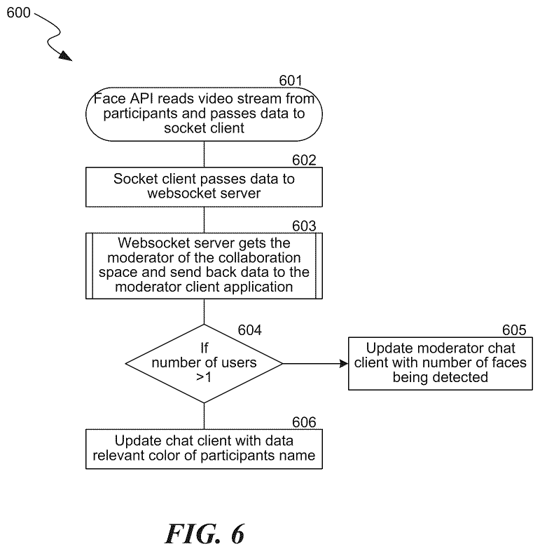

FIG. 6 is a flow diagram illustrating a process 600 used for displaying to a moderator in a collaboration room a number of faces and their expressions in each participant video stream according to one embodiment.

Process 600 begins at block 601. In some embodiments, block 601 is initiated as part of block 312 when a participant starts sharing their video stream. At block 602, the socket client 212 sends the participant data to the socket application 254. Then, at block 603, the socket application 254 uses peer data structure 290 and room data structure 291 to determine who the moderator(s) are for a selected collaboration room and sends the data back to the moderator client application 211. If the number of users in the collaboration room that are not moderators (e.g., participants) is greater than or equal to one (block 604), the face detection client 214 starts detecting presence of a number of faces (block 605) and corresponding facial expressions of each face (block 606) in the video stream of the participant. Face detection client 214 then uses the socket client 212 to send data as an object to the socket application 254. Based on the received data from the face detection client 214, the moderator's user interface is updated to show how many faces are present in each video stream and the color of each participant's name is changed based on the facial expression of the participant as described above.

The advantage of utilizing facial detection on client environment 10C is that the use of facial detection on the devices and not the servers saves on the computational needs on the server environment 10S. This allows for faster processing of the information at the servers instead of delays that would occur if the video stream from participants had to be managed and/or analyzed at the server environment 10S. There also is a considerable reduction in bandwidth needed at the server environment 10S as the server environment 10S only receives a small payload of data (e.g., 80 bytes/s) instead of video streams of a larger size (e.g., 5 Mbps and higher depending of quality of video being transmitted).

Several implementations of the disclosed technology are described above in reference to the figures. The computing devices on which the described technology may be implemented can be include one or more central processing units, memory, input devices (e.g., keyboard and pointing devices), output devices (e.g., display drives), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial up connection. Thus, computer-readable media can comprise computer-readable storage media (e.g., “non-transitory” media) and computer-readable transmission media.

References in this specification to “implementation” (e.g., “some implementation”, “various implementation”, “an implementation,” etc.) means that a particular feature, structure or characteristic described in connection with the implementation is included in at least one of the implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison ha a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “sends the highest probability score” can be understood to mean selecting a probability score that has the highest value among a group of generated probability scores.

As used herein, the word “or” refers to any possible permutation of a set of items. For example, the phrase “A, B, or C” refers to at least one of A, B, and C, or any combination therefore, such as any of A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1-20. (canceled)

21. A computer-implemented method for sharing data streams in a virtual collaboration environment, the computer-implemented method comprising:
receiving, from a first user device associated with a first user, a first data stream, the first data stream comprising a first video stream and a first screen sharing stream associated with at least one screen of the first user device;
receiving, from a second user device associated with a second user, a second data stream, the second data stream comprising a second video stream and a second screen sharing stream associated with at least one screen of the second user device;
generating a user interface, wherein generating the user interface comprises:
assigning the first data stream to a first section of the user interface such that the first video stream and the first screen sharing stream are both displayed within the first section; and
assigning the second data stream to a second section of the user interface such that the second video stream and the second screen sharing stream are both displayed within the second section, wherein the second section is positioned to be displayed simultaneously with the first section in the user interface; and
providing the user interface to be displayed on a screen of a third user device associated with a third user, wherein the user interface allows the third user to simultaneously view the first section and the second section on the screen such that the third user can simultaneously view, in real-time, the first video stream, the first screen sharing stream, the second video stream, and the second screen sharing stream.

22. The computer-implemented method of claim 21 wherein:
the first section of the user interface includes a first subsection and a second subsection, wherein the second subsection is at least partially overlayed on the first subsection, and wherein assigning the first data stream to the first section includes assigning the first screen sharing stream to the first subsection and assigning the first video stream to the second subsection; and
the second section of the user interface includes a third subsection and a fourth subsection, wherein the fourth subsection is at least partially overlayed on the third subsection, and wherein assigning the second data stream to the second section includes assigning the second screen sharing stream to the third subsection and assigning the second video stream to the fourth subsection.

23. The computer-implemented method of claim 21 wherein the first data stream is not provided to the second user device, and wherein the second data stream is not provided to the first user device.

24. The computer-implemented method of claim 21 wherein:
the computer-implemented method further comprises:
receiving, from a fourth user device associated with a fourth user, a fourth data stream comprising a fourth video stream and a fourth screen sharing stream associated with at least one screen of the fourth user device;
receiving first status information related to the first user and/or the first user device;
receiving second status information related to the second user and/or the second user device; and
receiving fourth status information related to the fourth user and/or the fourth user device; and
generating the user interface further comprises:
assigning the fourth data stream to a fourth section of the user interface such that the fourth video stream and the fourth screen sharing stream are both displayed within the fourth section, wherein the first section and the second section of the user interface are visible on a first page of the user interface, and wherein the fourth section of the user interface is visible on a second page of the user interface; and
assigning the first status information, the second status information, and the fourth status information to a fifth section of the user interface, wherein the fifth section is visible on the first page and on the second page of the user interface.

25. The computer-implemented method of claim 21, further comprising, after generating the user interface:
receiving, from a fourth user device associated with a fourth user, a fourth data stream comprising a fourth video stream and a fourth screen sharing stream associated with at least one screen of the fourth user device;
generating an update to the user interface, wherein generating the update comprises:
scaling the first section and the second section of the user interface to create room for a third section in the user interface; and
assigning the fourth data stream to the third section in the user interface such that the fourth video stream and the fourth screen sharing stream are displayed in the third section; and
providing the updated user interface to be displayed on the screen of the third user device.

26. The computer-implemented method of claim 21 wherein the first user device includes two or more screens, and wherein the computer-implemented method further comprises receiving a selection of which of the two or more screens to display via the first screen sharing stream in the first section of the user interface.

27. One or more non-transitory computer-readable media storing instructions that, when executed by an electronic processor, cause the electronic processor to execute a process, the process comprising:
for each individual participant of a plurality of participants of a virtual collaboration environment, receiving, at a server, a video stream and a screen sharing stream from a user device associated with the individual participant, wherein the screen sharing stream is associated with a participant screen on the user device associated with the individual participant;
generating, at the server, a user interface for a moderator of the virtual collaboration environment, wherein generating the user interface includes assigning the video stream and the screen sharing stream from each of the individual participants of the plurality of participants to an individual region of the user interface, wherein:
in each individual region, the video stream overlays the screen sharing stream in the individual region, and
the user interface is configured to display at least two of the individual regions simultaneously such that the user interface allows the moderator to visualize at least two of the plurality of participants simultaneously with at least two screen sharing streams; and
sending, from the server to a user device associated with the moderator, the user interface for display on a moderator screen at the user device associated with the moderator.

28. The one or more non-transitory computer-readable media of claim 27 wherein the process further comprises, before sending the user interface to the user device associated with the moderator:
receiving, at the server, credentials from the user device associated with the moderator; and
determining that the moderator should be assigned a moderator role in the virtual collaboration environment based on the received credentials.

29. The one or more non-transitory computer-readable media of claim 27 wherein the moderator is a first moderator, and wherein the process further comprises sending, from the server to a user device associated with a second moderator, the user interface for display on a moderator screen at the user device associated with the second moderator.

30. The one or more non-transitory computer-readable media of claim 27 wherein the moderator is a first moderator, wherein the user interface is a first user interface, and wherein the process further comprises:
generating, at the server, a second user interface for second moderator of the virtual collaboration environment, wherein generating the second user interface includes assigning the video stream and the screen sharing stream from each of the individual participants of the plurality of participants to an individual region of the second user interface, wherein:
in each of the individual regions, the video stream overlays the screen sharing stream in the individual region, and
the second user interface has a different organization than the first user interface; and
sending, from the server to a user device associated with a second moderator, the second user interface for display on a moderator screen at the user device associated with the second moderator.

31. The one or more non-transitory computer-readable media of claim 27 wherein the user interface is a moderator user interface, wherein the process further comprises:
receiving, at the server, a moderator video stream and a moderator screen sharing stream from the user device associated with the moderator; and
for each of the individual participants in the plurality of participants:
generating, at the server, an individual participant user interface for the individual participant, wherein generating the individual participant user interface includes assigning the moderator video stream and the moderator screen sharing stream a moderator region of the participant user interface, wherein the moderator video stream overlays the moderator screen sharing stream in the moderator region, and wherein participant user interface does not include a region for displaying the video stream and the screen sharing stream from other participants in the plurality of participants; and
sending, from the server to the user device associated with the individual participant, the individual participant user interface for display on the participant screen at the user device associated with the individual participant.

32. The one or more non-transitory computer-readable media of claim 31 wherein generating the individual participant user interface further includes assigning the video stream from the user device associated with the individual participant to a video monitoring region and assigning the screen sharing stream from the user device associated with the individual participant to a screen monitoring region.

33. The one or more non-transitory computer-readable media of claim 27 wherein:
the process further comprises, for each of the individual participants in the plurality of participants:
detecting, from the video stream from the user device associated with the individual participant, information related to the video stream, the information including one or more of:
an identity associated with each of one or more faces in the video stream;
a facial expression associated with each of the one or more faces in the video stream; and/or
a number of the one or more faces in the video stream; and
generating an indicator of the detected information; and
generating the user interface further includes, for each of the individual participants in the plurality of participants, assigning the indicator to a region to display to the moderator the detected information.

34. A computer-implemented method for sharing data streams in a virtual collaboration environment, the computer-implemented method comprising:
for each individual participant in a plurality of participants, receiving a video data stream and a screen sharing data stream from a participant user device associated with the individual participant, wherein the screen sharing data stream shares a real-time image of a screen of the participant user device;
determining, based on a peer data structure for each of the plurality of participants, a supervising user from the plurality of participants; and
for the supervising user, forwarding, to the participant user device associated with the supervising user, the video data stream and the screen sharing data stream associated with each non-supervising participant from the plurality of participants such that the participant user device associated with the supervising user can simultaneously display the video data stream and the screen sharing data stream for each non-supervising participant from the plurality of participants.

35. The computer-implemented method of claim 34, further comprising, for each other participant from the plurality of participants, forwarding only the video data stream and the screen sharing data stream associated with the supervising user.

36. The computer-implemented method of claim 35, further comprising sending, to each participant in the plurality of participants, an indication of a presence of each other participant in the virtual collaboration environment.

37. The computer-implemented method of claim 34, further comprising, for each individual non-supervising participant in the plurality of participants:
determining a number of faces present in the video data stream from the individual non-supervising participant; and
sending, to the participant user device associated with the supervising user, an indication of the number of faces present in the video data stream from the individual non-supervising participant.

38. The computer-implemented method of claim 34, further comprising:
receiving, from a new user device associated with a new user, a request to join the virtual collaboration environment; and
creating, based on information received from the new user device, a new peer data structure for the new user.

39. The computer-implemented method of claim 38 wherein the supervising user is a first supervising user, and wherein the computer-implemented method further comprises:
determining, based on the new peer data structure, the new user is a second supervising user; and
forwarding, to the new user device associated with the second supervising user, the video data stream and the screen sharing data stream associated with each non-supervising participant from the plurality of participants such that the new user device can simultaneously display the video data stream and the screen sharing data stream for each non-supervising participant from the plurality of participants.

40. The computer-implemented method of claim 38 wherein the request to join the virtual collaboration environment comprises credentials associated with the new user, and wherein the computer-implemented method further comprises authenticating the new user based on the credentials in the request to join the virtual collaboration environment.
